(19) United States
(12) Patent Application Publication
(10) Pub. No.: US 2026/0138462 A1
(43) Pub. Date: May 21, 2026

(54) POWER CONVERSION SYSTEM

(71) Applicant: TOYOTA JIDOSHA KABUSHIKI KAISHA, Toyota-shi (JP)

(72) Inventor: Kazuya TANIGUCHI, Okazaki-shi (JP)

(73) Assignee: TOYOTA JIDOSHA KABUSHIKI KAISHA, Toyota-shi (JP)

(21) Appl. No.: 19/355,310

(22) Filed: Oct. 10, 2025

(30) Foreign Application Priority Data
Nov. 15, 2024 (JP) 2024-199766

(51) Int. Cl. B60L 15/00; H02J 7/00

(52) U.S. Cl. CPC B60L 15/007; H02J 7/865

(57) ABSTRACT

The power conversion system includes a power receiving port, a power supply port, a power conversion device, a first switch, a second switch, a control device configured to output a control signal for controlling open or closed states of the first switch and the second switch, a first signal line, a second signal line, and an inverter circuit. The first signal line is disposed between one of the first switch and the second switch and the control device. The second signal line branches from the first signal line and is disposed between the first switch and the other switch of the second switch at a branch point. The inverter circuit is provided on the first signal line and outputs an inverted signal of the control signal.

### CROSS-REFERENCE TO RELATED APPLICATION

This application claims priority to Japanese Patent Application No. 2024-199766 filed on November 15, 2024. The disclosure of the above-identified application, including the specification, drawings, and claims, is incorporated by reference herein in its entirety.

### BACKGROUND

### 1. Technical Field

The present disclosure relates to a power conversion system.

### 2. Description of Related Art

Japanese Unexamined Patent Application Publication No. 2015-142409 (JP 2015-142409 A) discloses a vehicle. The vehicle includes an inlet, a charger, a charging relay, a power storage device, an in-vehicle outlet, and a direct current (DC)/alternating current (AC) inverter. The inlet is a power receiving port that receives supply power from an external power supply. The charger converts the received supply power to charge the power storage device in a case where the charging relay is in a closed state (external charging). The in-vehicle outlet is a power supply port to which electric equipment is connected. The DC/AC inverter converts power of the power storage device to supply the converted power to the power supply port as discharge power (external power supply). The DC/AC inverter is operated after a voltage of its output node is confirmed to be 0 V in order to avoid a collision between a charge power and the discharge power.

### SUMMARY

A vehicle may include a power conversion device that is bidirectional and is capable of executing both a function of external charging and a function of external power supply in a single unit. In this case, a first switch may be provided in a first power supply line extending from a power receiving port to the power conversion device, and a second switch may be provided in a second power supply line extending from the first power supply line to a power supply port. During the external charging, it is preferable that one switch of the first switch and the second switch be controlled to be in an open state such that one of the first power supply line and the second power supply line is in a non-conducting state. This is because a voltage of supply power often differs from an operating voltage of the electric equipment, and to prevent unintentional application of the voltage of the supply power to electric equipment when the power receiving port and the power supply port are electrically connected.

However, the one switch to be controlled to be in the open state during the external charging may be unintentionally closed because of an abnormality in its control system or the like. As a result, there is a possibility that both the first and second power supply lines are in a conducting state and the power receiving port and the power supply port are electrically connected. In this case, there is a possibility that the voltage of the supply power is unintentionally applied to the electric equipment.

The present disclosure has been made to solve the issue described above, and provides a power conversion system capable of inhibiting a voltage of supply power from outside the vehicle from being unintentionally applied to electric equipment connected to a power supply port of the vehicle.

A power conversion system of the present disclosure is mounted on a vehicle. The power conversion system includes a power receiving port, a power supply port, a power conversion device that is bidirectional, a first switch, a second switch, a control device, a first signal line, a second signal line, and an inverter circuit. The power receiving port receives power supplied from a power supply facility outside the vehicle. Electric equipment is connected to the power supply port. The power conversion device converts the power received by the power receiving port and charges a power storage device of the vehicle, or converts power of the power storage device and supply the power to the power supply port. The first switch is provided in a first power supply line extending from the power receiving port to the power conversion device. The second switch is provided in a second power supply line extending from a portion of the first power supply line between the first switch and the power conversion device to the power supply port. The control device outputs a control signal for controlling an open or closed state of each of the first switch and the second switch. The first signal line is disposed between the control device and one switch of the first switch and the second switch. The second signal line branches from the first signal line at a first branch point and is disposed between the first branch point and the other switch of the first switch and the second switch. The inverter circuit is provided in the first signal line between the one switch and the first branch point. The inverter circuit outputs an inverted signal of the control signal.

According to the present disclosure, it is possible to inhibit a voltage of supply power from outside the vehicle from being unintentionally applied to electric equipment connected to a power supply port of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of a vehicle on which a power conversion system according to an embodiment is mounted;

FIG. 2 is a diagram for describing a detailed configuration of the charge/power supply unit;

FIG. 3 is a diagram illustrating a relationship between a signal level Lv1 and the open or closed state of the relay, and signal levels Lv2, Lv3, the relationship being assumed in a normal state in which there is no abnormality in the charge/power supply unit;

FIG. 4 is a flowchart for describing an example of processing by the control device;

FIG. 5 is a flowchart for describing another example of the processing by the control device; and

FIG. 6 is an overall configuration diagram of a vehicle on which the power conversion system according to modification 2 is mounted.

### DETAILED DESCRIPTION OF EMBODIMENTS

Hereinafter, an embodiment of the present disclosure will be described in detail with reference to the drawings. The same or corresponding parts in the drawings are denoted by the same reference numerals, and the description thereof will not be repeated.

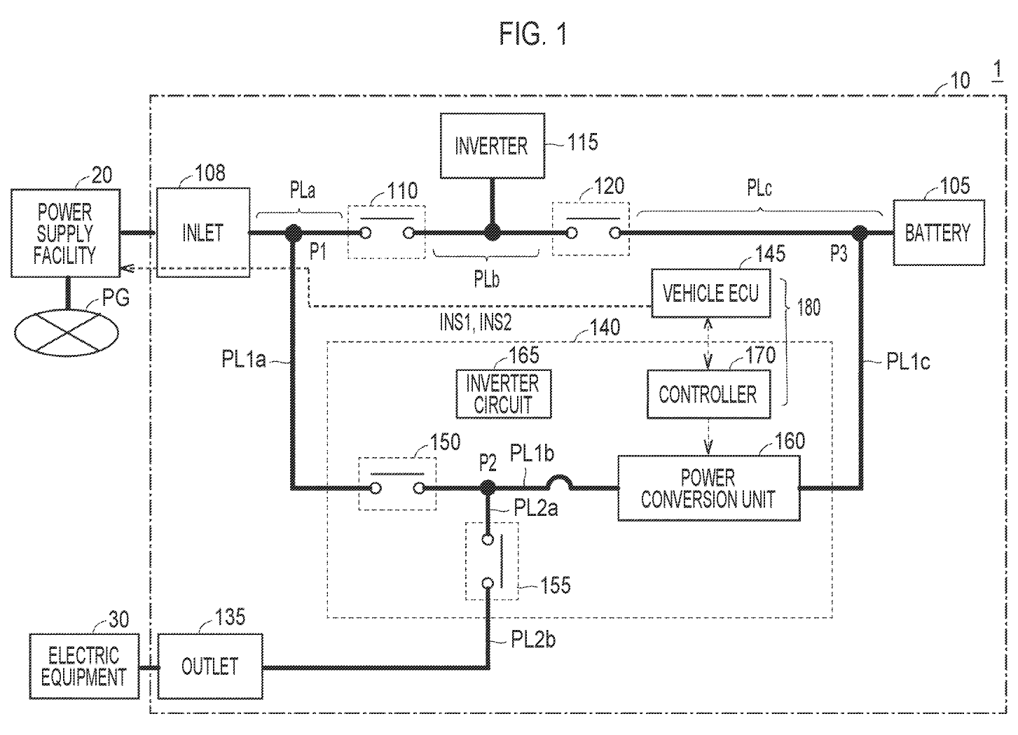

FIG. 1 is an overall configuration diagram of a vehicle on which a power conversion system according to an embodiment is mounted. With reference to FIG. 1, the vehicle 10 includes a battery 105, an inlet 108, a charge/power supply relay 110, an inverter 115, and a system main relay (SMR) 120. The vehicle 10 further includes an outlet 135, a charge/power supply unit 140, and a vehicle electronic control unit (ECU) 145.

The battery 105 is a high-voltage power storage device that stores power for traveling of the vehicle 10, and is a rechargeable secondary battery, such as a lithium ion battery.

The inlet 108 is connected to the power supply facility 20 outside the vehicle 10, and is a power receiving port that receives supply power from the power supply facility 20. The power supply facility 20 is connected to a power grid PG. The supply power may be any of alternating current power or direct current power.

The charge/power supply relay 110 is connected between the power lines PLa, PLb. The inverter 115 drives a motor (not shown) for traveling of the vehicle 10. The SMR 120 is connected between the power lines PLb, PLc. The charge/power supply relay 110 and the SMR 120 are closed, for example, in a case where the supply power is direct current power or when the system power supply (described below) is performed.

The outlet 135 is installed in the vehicle cabin of the vehicle 10, and the electric equipment 30 is connected to the outlet 135. The electric equipment 30 is electric equipment different from a component of the vehicle 10, and is, for example, a home appliance that operates by receiving 100 V of alternating current power from the outlet 135.

The charge/power supply unit 140 includes relays 150, 155, a power conversion unit 160, an inverter circuit 165, and a controller 170.

The relay 150 is, for example, a normally open contact relay (an a-contact relay), and corresponds to a switch connected between the power lines PL1a, PL1b. The power line PL1a is a power line branched from the power line PLa at a branch point P1. The relay 150 is provided to execute external charging or system power supply (both will be described later). The relay 155 is a normally open contact relay, and corresponds to a switch connected between the power lines PL2a, PL2b. The power line PL2a is a power line branched from the power line PL1b at a branch point P2. The relay 155 is provided to perform regular power supply (described later).

Each of the relays 150, 155 is turned on and off according to an applied voltage to the coil (not shown). For example, for each of the relays, the relay is closed when the applied voltage to the coil exceeds the operation voltage of the relay, and the relay is opened when the applied voltage is lower than the return voltage of the relay. In the embodiment, it is assumed that the operation voltage and the return voltage of the relays 150, 155 are the same. The return voltage is higher than zero voltage (0 V) and lower than the operating voltage.

The power conversion unit 160 is a bidirectional power conversion device and is connected between the power lines PL1b, PL1c. The power line PL1c is a power line branched from the power line PLc at a branch point P3. The power conversion unit 160 converts the power received by the inlet 108 to charge the battery 105 (external charging) when the relay 150 is in the closed state. Alternatively, the power conversion unit 160 converts the power of the battery 105 (or direct current power supplied from the power supply facility 20 through the charge/power supply relay 110 and the SMR 120) and supplies the converted power to the outlet 135 when the relay 155 is in the closed state. As a result, the power is supplied to the electric equipment 30 by the power after the conversion.

The power supply from the vehicle 10 to the outside of the vehicle 10 is also referred to as "external power supply". The external power supply in a case where the power supply target is the power grid PG is also referred to as "system power supply". The external power supply in a case where the power supply target is the electric equipment 30 is also referred to as "regular power supply". In a case of regular power supply, it is preferable that the relay 150 is controlled to be in an open state and the relay 155 is controlled to be in a closed state. The same applies even in a case where the regular power supply is performed during the system power supply. As described above, the power conversion unit 160 can execute both the external charging and the external power supply with one device.

The power supply line extending from the inlet 108 to the power conversion unit 160 is also referred to as a "first power supply line". The first power supply line corresponds to a portion of the power line PLa between the inlet 108 and the branch point P1, and the power transmission path constituted by the power lines PL1a, PL1b, and the relay 150. A power supply line extending from the power line PL1b (in detail, the branch point P2) to the outlet 135 is also referred to as a "second power supply line". The second power supply line corresponds to a power transmission path constituted by the power lines PL2a, PL2b, and the relay 155. The power supply line extending from the inlet 108 to the battery 105 is also referred to as a "third power supply line". The third power supply line corresponds to a power transmission path constituted by the power lines PLa, PLb, PLc, the charge/power supply relay 110, and the SMR 120.

The controller 170 is a control circuit that controls the relays 150, 155, and the power conversion unit 160. The controller 170 executes external charging control for controlling the external charging. The external charging control includes generating a control signal (described later) for controlling the open or closed states of the relays 150, 155 and operating the power conversion unit 160. In this case, the relays 150, 155 are controlled to be in the closed state and the open state, respectively, and the power conversion unit 160 is controlled to convert the supply power. The inverter circuit 165 will be described in detail later.

The vehicle ECU 145 corresponds to an ECU higher than the controller 170, and controls the charge/power supply relay 110, the SMR 120, and the charge/power supply unit 140. The vehicle ECU 145 and the controller 170 monitor states of each other. For example, the vehicle ECU 145 can determine whether the controller 170 is normal in accordance with a result of monitoring the controller 170. The vehicle ECU 145 and the controller 170 are also referred to as a "control device 180".

The vehicle ECU 145 can communicate with the power supply facility 20 by a controller area network (CAN) communication or the like. The vehicle ECU 145 executes the external charging control by generating a control command, such as the power supply start command INS1 or the power supply stop command INS2, and transmitting the control command to the power supply facility 20. In this case, the external charging control further includes transmitting the power supply start command INS1 after closing the charge/power supply relay 110 and the SMR 120, and opening the charge/power supply relay 110 and the SMR 120 after transmitting the power supply stop command INS2.

The inlet 108, the charge/power supply relay 110, the SMR 120, the outlet 135, the charge/power supply unit 140, and the vehicle ECU 145 are examples of a "power conversion system" of the present disclosure. The same applies to the modifications 1, 2 described below.

It is preferable that, during the external charging, the relay of one of the relays 150, 155 is controlled to be in the open state such that one of the first power supply line and the second power supply line is in a non-conducting state. This is because the voltage of the supply power is often different from the operating voltage of the electric equipment 30, and the inlet 108 and the outlet 135 are electrically connected to inhibit the voltage of the supply power from being unintentionally applied to the electric equipment 30.

For example, in a case where the supply power (direct current power) is supplied to the battery 105 through the charge/power supply relay 110 and the SMR 120, it is preferable that the relay 150 is controlled to be in the open state in order to close the relay 155 and perform the regular power supply. Alternatively, in a case where the relay 150 is controlled to be in the closed state and the supply power is supplied to the power conversion unit 160 and the power after being converted by the power conversion unit 160 is supplied to the battery 105, it is preferable that the relay 155 is controlled to be in the open state.

However, the one relay that should be controlled to the open state during the external charging may be unintentionally closed due to an abnormality in a control system such as the controller 170 or in the signal transmission path. As a result, both the first and second power supply lines may be in a conducting state, and the inlet 108 and the outlet 135 may be electrically connected. In this case, the voltage of the supply power may be applied to the electric equipment 30 unintentionally, which is not preferable. Even in a case where the regular power supply is executed during the system power supply in which the charge/power supply relay 110 and the SMR 120 are controlled to be in the closed state, it is not preferable that the voltage of the battery 105 is applied to the electric equipment 30 unintentionally.

In contrast, the charge/power supply unit 140 according to the embodiment has a configuration for dealing with such a problem. Hereinafter, this point will be described in detail.

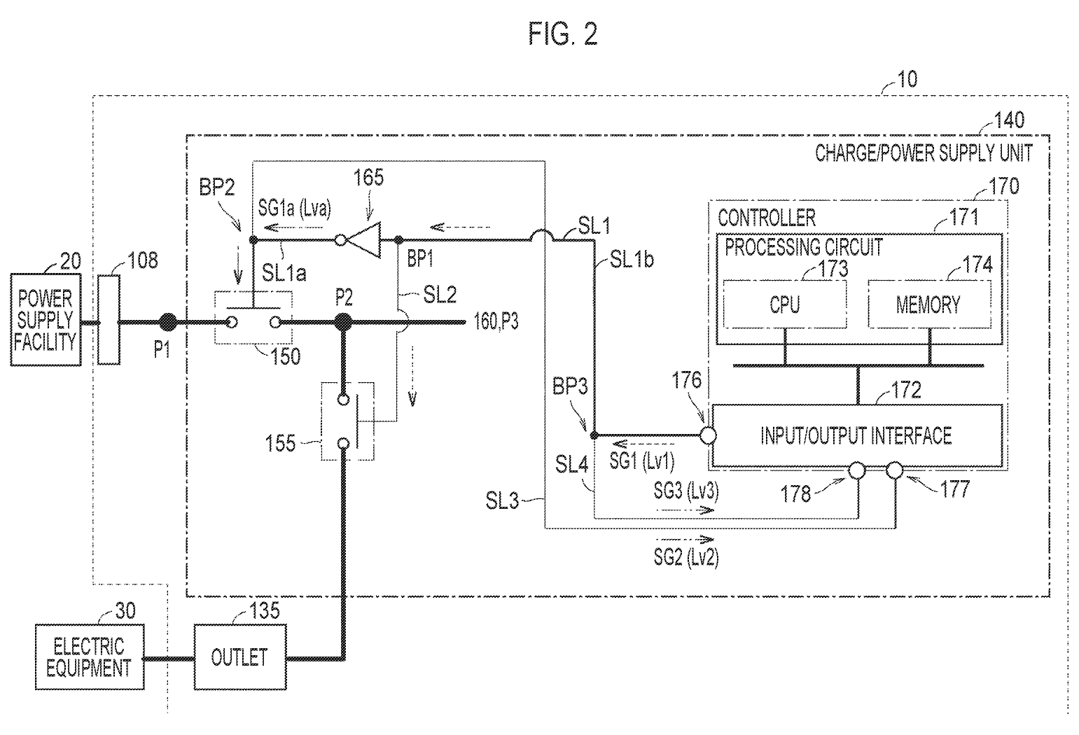

FIG. 2 is a diagram for describing a detailed configuration of the charge/power supply unit 140. With reference to FIG. 2, the charge/power supply unit 140 includes relays 150, 155, a controller 170, signal lines SL1 to SL4, and an inverter circuit 165.

The controller 170 includes a processing circuit 171 and an input/output interface 172. The processing circuit 171 includes a central processing unit (CPU) 173 and a memory 174. The CPU 173 executes various arithmetic processes by reading out the program stored in the memory 174. As a result, the processing circuit 171 generates the control signal SG1 for controlling the open or closed state of the relays 150, 155. Information indicating an output level of the control signal SG1 (details will be described later) is stored in the memory 174.

The input/output interface 172 includes an output terminal 176, and input terminals 177, 178. The control signal SG1 is output from the output terminal 176. The output terminal 176 and the input terminals 177, 178 are connected to the signal lines SL1, SL3, SL4, respectively.

The control signal SG1 is a voltage signal for controlling the open or closed states of the relays 150, 155. The level (output level) of the control signal SG1 output from the output terminal 176 is also referred to as a signal level Lv1. The signal level Lv1 is any of a logic high (H) level and a logic low (L) level. The signal level Lv1 is stored in an output buffer of the controller 170 in the memory 174. The signal level Lv1 corresponds to an example of the "first signal level" in the present disclosure. In this example, in a case where the signal level Lv1 is the H level, the applied voltage to the coil of the relay 155 is equal to or higher than the operation voltage, and thus the relay 155 is controlled to the closed state. On the other hand, in a case where the signal level Lv1 is the L level, the applied voltage to the coil of the relay 155 is less than the return voltage, and thus the relay 155 is controlled to be in the open state. The signal line SL1 is disposed between the relay 150 and the output terminal 176 to constitute a signal path from the controller 170 to the relay 150.

The inverter circuit 165 is provided on the signal line SL1 and outputs an inverted signal SG1a of the control signal SG1. The inverted signal SG1a has a signal level Lva, which is different from the signal level Lv1. For example, when the signal level Lv1 is the H level, the signal level Lva is the L level. On the other hand, when the signal level Lv1 is the L level, the signal level Lva is the H level. The inverted signal SG1a is transmitted from an output terminal of the inverter circuit 165 to the coil of the relay 150 through the signal line SL1a. The signal line SL1a is a portion of the signal line SL1 between the output terminal of the inverter circuit 165 and the relay 150. When the signal level Lva is the H level, the applied voltage to the coil of the relay 150 is equal to or higher than the operation voltage, and thus the relay 150 is controlled to be in the closed state. On the other hand, in a case where the signal level Lva is the L level, the applied voltage to the coil of the relay 150 is less than the return voltage, and thus the relay 150 is controlled to be in the open state.

The signal line SL2 branches from the signal line SL1b at a branch point BP1 and is disposed between the relay 155 and the branch point BP1. The signal line SL1b corresponds to a portion of the signal line SL1 between the input terminal of the inverter circuit 165 and the output terminal 176. The control signal SG1 is transmitted through the signal line SL1b. The control signal SG1 is transmitted not only to the input terminal of the inverter circuit 165 but also to the coil of the relay 155 through the signal line SL2 via the signal line SL1b.

The signal line SL3 branches from the signal line SL1a at a branch point BP2 and is disposed between the branch point BP2 and the input terminal 177. The signal SG2 is transmitted through the signal line SL3. The signal SG2 corresponds to an input signal input to the input terminal 177 through the signal line SL3 from the signal line SL1a. The signal SG2 has a signal level Lv2. The signal level Lv2 is any of the H level and the L level, and is the same as the signal level Lva. The signal level Lv2 corresponds to an example of the "second signal level" in the present disclosure. The signal SG2 is the same as the inverted signal SG1a as long as no abnormality, such as disconnection of the signal line SL1a, occurs. In this case, the signal level Lv2 is different from the signal level Lv1 as long as the abnormality does not occur in the inverter circuit 165.

The signal line SL4 branches from the signal line SL1b at a branch point BP3 and is disposed between the branch point BP3 and the input terminal 178. The signal SG3 is transmitted through the signal line SL4. The signal SG3 corresponds to the input signal input to the input terminal 178 via the signal line SL4 from the signal line SL1b. The signal SG3 has a signal level Lv3, and the level is any of an H level or an L level. As long as no abnormality such as disconnection of the signal line SL1b (in detail, a portion between the branch point BP3 and the output terminal 176 of the signal line SL1b) occurs, the signal level Lv3 is equal to the signal level Lv1 because the signal SG3 is the same as the control signal SG1.

According to the above-described configuration of the charge/power supply unit 140, the control signal SG1 is transmitted to the relay 155, while the inverted signal SG1a is transmitted to the relay 150. As a result, the open or closed states of the relays 150, 155 are controlled complementarily to each other in accordance with the single control signal SG1 output from the same control circuit (controller 170). As a result, even in a case where the control signal SG1 is changed unintentionally due to some abnormal cause and one of the relays 150, 155 (the relay to be controlled to the open state) is closed, the switch of the other relay is opened. Therefore, a situation in which the relays are in the closed state at the same time is avoided. Therefore, it is possible to inhibit the voltage of the supply power from being applied to the electric equipment 30 through the outlet 135 during the external charging. As a result, the electric equipment 30 can be appropriately protected from the voltage of the supply power. Even when some kind of abnormality occurs in a case where the regular power supply is performed during the system power supply, a situation in which the relays 150, 155 are brought into the closed state at the same time for the same reason as described above is avoided. Therefore, the electric equipment 30 can be appropriately protected.

The processing circuit 171 of the controller 170 can determine the presence or absence of the abnormality of the charge/power supply unit 140 (for example, the abnormality of the inverter circuit 165 or the signal line SL1) according to the signal levels Lv1, Lv2, and Lv3. The determination process is also referred to as an "abnormality determination process". For example, in the abnormality determination process, the controller 170 determines that the abnormality is not present in a case where (a) the signal level Lv1 is equal to the signal level Lv3 and the signal level Lv1 is different from the signal level Lv2. On the other hand, the controller 170 determines that the abnormality is present in a case where (b) the signal level Lv1 is different from the signal level Lv3 or (c) the signal level Lv1 is equal to the signal level Lv3 and the signal level Lv1 is equal to the signal level Lv2. The abnormality determination process is executed, for example, during external charging, during system power supply, or during regular power supply.

When the inverter circuit 165 or the signal line SL1 is in an abnormal state, the signal level Lv2 may be the same as the signal level Lv1. Therefore, the signal level Lv2 can reflect the abnormality of the inverter circuit 165 or the signal line SL1. Therefore, by the abnormality determination process, the presence or absence of the abnormality in the inverter circuit 165 or the signal line SL1 can be appropriately determined.

For example, when both the signal levels Lv1, Lv2 are at the H level, both the relays 150, 155 may be in the closed state. On the other hand, the controller 170 can execute appropriate processing in a case where the abnormality is determined to be present in the abnormality determination processing. As a result, a situation in which both the relays 150, 155 are unintentionally brought into the closed state can be avoided.

The appropriate process is, for example, a process in which the controller 170 sets the signal level Lv1 such that the control signal SG1 indicates the opening of the relay 155 (in this example, switching from the H level to the L level). As a result, the relay 155 is opened, so that the electric equipment 30 can be insulated from the power supply facility 20. As a result, the external charging can be continued while the voltage of the supply power is inhibited from being unintentionally applied to the electric equipment 30 through the outlet 135.

The appropriate process may be a process of notifying the vehicle ECU 145 of the determination result that there is the abnormality. In response to the notification, the vehicle ECU 145 transmits the power supply stop command INS2 to the power supply facility 20. As a result, the supply of the supply power from the power supply facility 20 to the inlet 108 is stopped. As a result, it is possible to execute the regular power supply while the voltage of the supply power is inhibited from being applied to the electric equipment 30 through the outlet 135 without intention.

For example, when the controller 170 cannot normally output the control signal SG1 due to the internal abnormality, the signal level Lv3 may be different from the signal level Lv1. The case where the control signal SG1 cannot be normally output due to the internal abnormality is, for example, a case where the signal level Lv1 stored in the output buffer and the output level of the control signal SG1 actually output from the output terminal 176 are different from each other. Therefore, the internal abnormality or the presence or absence of the abnormality of the signal line SL1b (in detail, the portion between the branch point BP3 and the output terminal 176) can be determined according to the signal levels Lv1, Lv3. For example, in a case where the signal level Lv1 and the signal level Lv3 are different from each other, the controller 170 determines that the abnormality is present. The controller 170 may notify the vehicle ECU 145 of the determination result that the abnormality is present. On the other hand, in a case where the signal level Lv1 and the signal level Lv3 are equal to each other, the controller 170 determines that there is no abnormality.

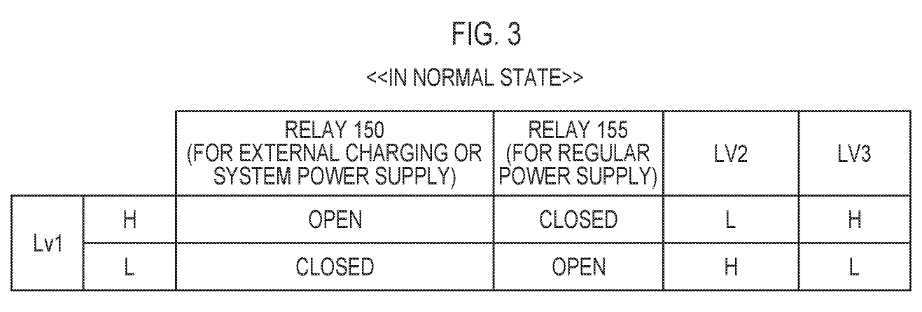

FIG. 3 is a diagram illustrating a relationship between a signal level Lv1 assumed in a normal state in which there is no abnormality in the charge/power supply unit 140, the open or closed states of the relays 150, 155, and signal levels Lv2, Lv3.

With reference to FIG. 3, in a case where the signal level Lv1 is at the H level, it is assumed that the signal level Lva is at the L level in a normal state. Therefore, it is assumed that the relays 150, 155 are in the open state and the closed state, respectively. Then, since the signal level Lv2 is assumed to be equal to the signal level Lva (different from the signal level Lv1), the signal level Lv2 is assumed to be the L level. On the other hand, since the signal level Lv3 is assumed to be equal to the signal level Lv1, the signal level Lv3 is assumed to be the H level.

Therefore, when the signal level Lv1 is the H level, the controller 170 can determine that there is no abnormality in the charge/power supply unit 140 when the signal levels Lv2, Lv3 are the L and H levels, respectively. On the other hand, when the signal level Lv2 is the H level or the signal level Lv3 is the L level, the controller 170 determines that such an abnormality occurs.

On the other hand, in a case where the signal level Lv1 is the L level, it is assumed that the signal level Lva is the H level in a normal state. Therefore, it is assumed that the relays 150, 155 are in the closed state and the open state, respectively. Then, since the signal level Lv2 is assumed to be equal to the signal level Lva (different from the signal level Lv1), the signal level Lv2 is assumed to be the H level. On the other hand, since the signal level Lv3 is assumed to be equal to the signal level Lv1, the signal level Lv3 is assumed to be the L level.

Therefore, when the signal level Lv1 is the L level, the controller 170 can determine that there is no abnormality in the charge/power supply unit 140 when the signal levels Lv2, Lv3 are the H level and the L level, respectively. On the other hand, when the signal level Lv2 is the L level or the signal level Lv3 is the H level, the controller 170 determines that such an abnormality occurs.

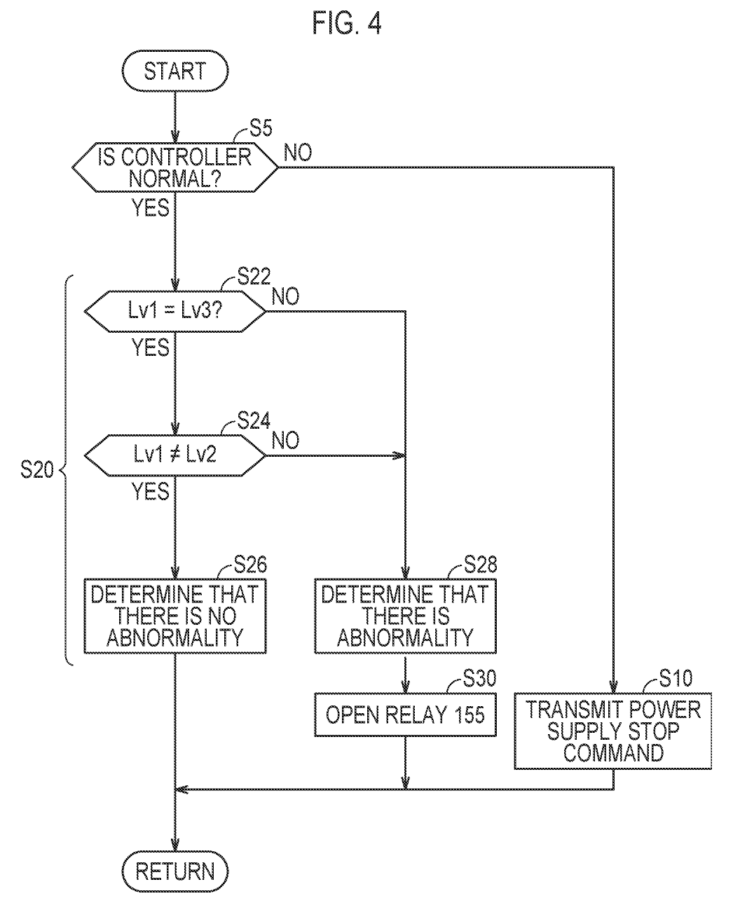

FIG. 4 is a flowchart for describing an example of processing by the control device 180. With reference to FIG. 4, the flowchart is executed at a predetermined time interval, for example, during external charging. Hereinafter, the steps are abbreviated as "S".

The vehicle ECU 145 determines whether the controller 170 is normal (S5). When the controller 170 is abnormal (NO in S5), the vehicle ECU 145 transmits the power supply stop command INS2 to the power supply facility 20 (S10). Thereafter, the process shifts to the return.

When the controller 170 is normal (YES in S5), the controller 170 executes the abnormality determination process (S20). In this example, the following S22 to S28 are executed as S20.

The controller 170 determines whether the signal level Lv1 is equal to the signal level Lv3 (S22). When the signal level Lv1 is different from the signal level Lv3 (NO in S22), the process proceeds to S28. On the other hand, in a case where the signal level Lv1 is equal to the signal level Lv3 (YES in S22), the process proceeds to S24.

The controller 170 determines whether the signal level Lv1 is different from the signal level Lv2 (S24). When the signal level Lv1 is different from the signal level Lv2 (YES in S24), the controller 170 determines that there is no abnormality in the charge/power supply unit 140 (S26). Thereafter, the process shifts to the return. When the signal level Lv1 is equal to the signal level Lv2 (NO in S24), the process proceeds to S28.

The controller 170 determines that the charge/power supply unit 140 is abnormal (S28). For example, when the signal level Lv1 is different from the signal level Lv3 (NO in S22), the controller 170 determines that there is an internal abnormality or an abnormality in the signal line SL1b (in detail, a part between the branch point BP3 and the output terminal 176). Alternatively, in a case where the signal level Lv1 is equal to the signal level Lv2 (NO in S24), the determination is made that there is an abnormality in the inverter circuit 165 or the signal line SL1. The controller 170 may notify the vehicle ECU 145 of the determination result that there is the abnormality in S28. In this case, the vehicle ECU 145 transmits the power supply stop command INS2 to the power supply facility 20.

The controller 170 sets the signal level Lv1 to indicate the opening of the relay 155 (for example, to the L level) by the control signal SG1 (S30). Thereafter, the process shifts to the return. In the above, S22 may be omitted under the premise that the internal abnormality of the controller 170 or the abnormality of the signal line SL1b does not occur. In this case, the abnormality determination process is executed according to the signal level Lv1 and the signal level Lv2, and the process proceeds to S24 after S5.

As described above, according to the embodiment, even in a case where one of the relays 150, 155 is closed due to an unintended change in the control signal SG1 or the like, the other relay is opened. Therefore, a situation in which the relays are in the closed state at the same time is avoided. Therefore, it is possible to inhibit the voltage of the supply power from being unintentionally applied to the electric equipment 30 through the outlet 135.

### Modification 1

The signal levels Lv2, Lv3 may suddenly change due to some cause, such as noise. In this case, it is not preferable that the abnormality is erroneously determined to be present in the abnormality determination process even though the charge/power supply unit 140 is not actually abnormal.

Therefore, in the abnormality determination process, the controller 170 may determine that the abnormality occurs in the charge/power supply unit 140 only when the state in which the inconsistency that is predetermined occurs between the signal levels Lv1, Lv2, Lv3 (inconsistent state) continues for the predetermined time or longer. The controller 170 counts the time during which the inconsistent state continues, for example, from when the inconsistent state is started (in the example, when both the signal levels Lv2, Lv3 are set to the H level). Then, when the counted time exceeds the predetermined time, the abnormality determination process is executed. The inconsistent state may be, for example, a state in which the signal level Lv1 is different from the signal level Lv3 (NO in S22 of FIG. 4), or a state in which the signal level Lv1 is equal to the signal level Lv2 (NO in S24 of FIG. 4).

By executing the abnormality determination process as described above, even in a case where the signal levels Lv2, Lv3 are varied, determination is inhibited from being made that there is an abnormality when the duration of the inconsistent state is less than a predetermined time. Therefore, the above-mentioned misjudgment in the abnormality determination process can be avoided.

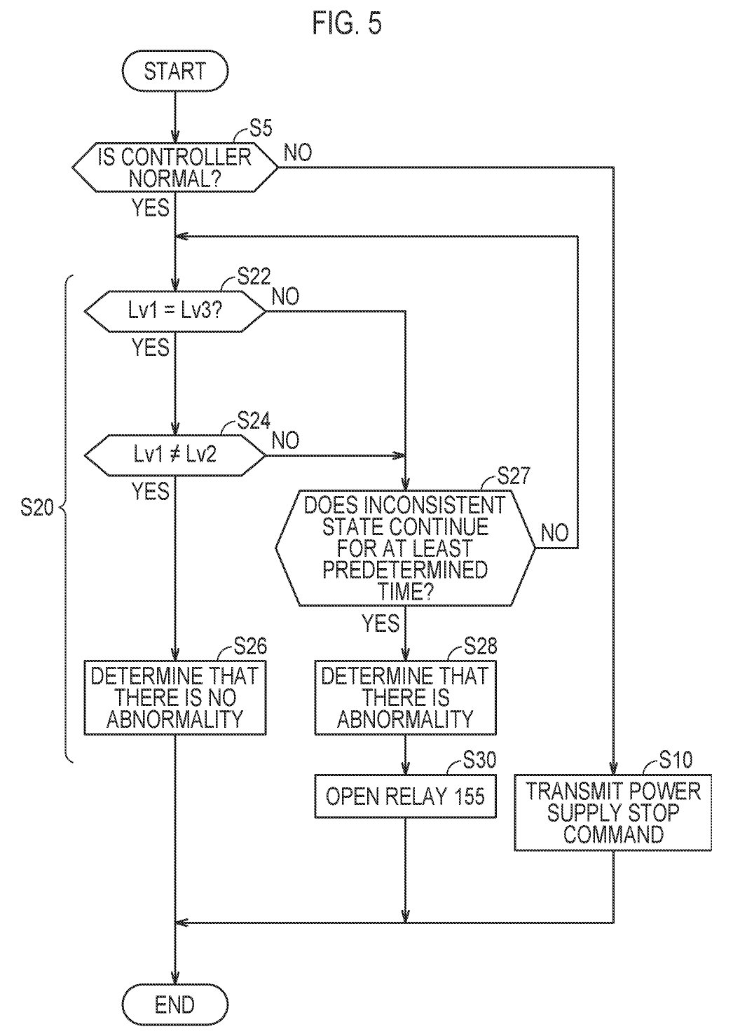

FIG. 5 is a flowchart for describing another example of the processing by the control device 180. With reference to FIG. 5, the flowchart is the same as the flowchart of the embodiment (FIG. 4) except that S20 further includes S27. Therefore, a detailed description will not be repeated.

When the signal level Lv1 is different from the signal level Lv3 (NO in S22), the controller 170 determines whether the inconsistent state continues for a predetermined time or longer (S27). Alternatively, in a case where the signal level Lv1 is equal to the signal level Lv2 (NO in S24), the controller 170 determines whether the inconsistent state continues for a predetermined time or longer (S27). When the inconsistent state is not continued for a predetermined time or longer (NO in S27), the process returns to S22. In this case, S22, S24, and S27 can be repeated. When the inconsistent state continues for a predetermined time or longer (YES in S27), the controller 170 determines that the abnormality of the charge/power supply unit 140 is present (S28). In this example, S22 may be omitted as in the embodiment. In this case, the inconsistent state is a state in which the signal level Lv1 is equal to the signal level Lv2.

As described above, according to the modification 1, it is possible to avoid the erroneous determination in the abnormality determination process due to the sudden fluctuation of the signal levels Lv2, Lv3.

### Modification 2

In the above, the inverter circuit 165 is provided between the branch point BP1 and the relay 150, but may be provided between the branch point BP1 and the relay 155.

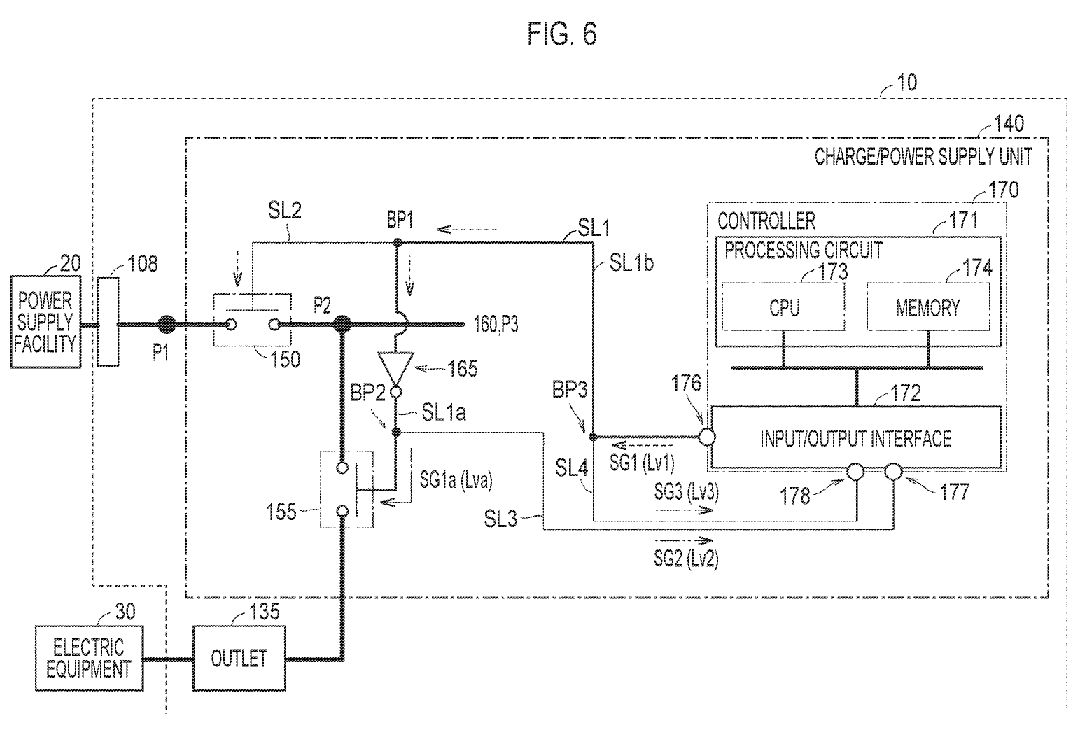

FIG. 6 is an overall configuration diagram of a vehicle on which the power conversion system according to the modification 2 is mounted. With reference to FIG. 6, the charge/power supply unit 142 is different from the charge/power supply unit 140 (FIGS. 1 and 2) in the position of the inverter circuit 165 and the signal lines SL1, SL2, SL3. In the specific example, (1) the signal line SL1 to which the inverter circuit 165 is provided is disposed between the relay 155 and the output terminal 176. (2) The signal line SL2 branches from the signal line SL1 at the branch point BP1 and is disposed between the relay 150 and the branch point BP1. (3) The signal line SL3 branches from the signal line SL1a at the branch point BP2 and is disposed between the input terminal 177 and the branch point BP2. Regarding points other than (1) to (3), the charge/power supply unit 142 is basically the same as the charge/power supply unit 140. Therefore, a detailed description will not be repeated.

In the modification 2, the control signal SG1 is transmitted to the relay 150, and the inverted signal SG1a is transmitted to the relay 155. As a result, the open or closed states of the relays 150, 155 are controlled complementarily to each other in accordance with the single control signal SG1 output from the same control circuit (controller 170). As a result, a situation in which the relays are in the closed state at the same time is avoided. Therefore, it is possible to inhibit the voltage of the supply power from being applied to the electric equipment 30 through the outlet 135 during the external charging. Even in a case where the regular power supply is performed during the system power supply, the electric equipment 30 can be appropriately protected for the same reason as described above.

The controller 170 executes the abnormality determination process according to the signal levels Lv1, Lv2, and Lv3. For example, in the case of (a) described above, the determination is made that there is no abnormality in the charge/power supply unit 140, and in the case of (b) or (c) described above, the determination is made that there is the abnormality. The controller 170 may determine that the abnormality is present solely when the inconsistent state as the state of (b) or (c) continues for a predetermined time or longer.

Also in the modification 2, the abnormality determination process can be executed during external charging, during system power supply, or during regular power supply. The controller 170 sets the signal level Lv1 to the H level such that the control signal SG1 instructs the opening of the relay 155, for example, when determination is made that there is the abnormality. Alternatively, in a case where the determination is made in such a manner, the controller 170 may notify the vehicle ECU 145 of the determination and the vehicle ECU 145 may transmit the power supply stop command INS2 to the power supply facility 20.

The embodiments disclosed herein should be considered illustrative and not restrictive in all respects. The scope of the disclosure is shown by the scope of claims rather than the above description, and is intended to include all modifications within the meaning and scope equivalent to the scope of claims.

What is claimed is:

1. A power conversion system mounted on a vehicle, the power conversion system comprising:
a power receiving port configured to receive power supplied from a power supply facility outside the vehicle;
a power supply port to which electric equipment is connected;
a power conversion device configured to
convert the power received by the power receiving port and charge a power storage device of the vehicle, or
convert power of the power storage device and supply the power to the power supply port, the power conversion device being bidirectional;
a first switch provided in a first power supply line extending from the power receiving port to the power conversion device;
a second switch provided in a second power supply line extending from a portion of the first power supply line between the first switch and the power conversion device to the power supply port;
a control device configured to output a control signal for controlling an open or closed state of each of the first switch and the second switch;
a first signal line disposed between the control device and one switch of the first switch and the second switch;
a second signal line branching from the first signal line at a first branch point and disposed between the first branch point and the other switch of the first switch and the second switch; and
an inverter circuit provided in the first signal line between the one switch and the first branch point, the inverter circuit being configured to output an inverted signal of the control signal.

2. The power conversion system according to claim 1, further comprising a third signal line branching from a portion of the first signal line between an output terminal of the inverter circuit and the one switch, wherein:
the control device includes
a first input terminal connected to the third signal line, and
a processing circuit configured to execute, in accordance with a first signal level and a second signal level, a determination process of determining whether there is an abnormality in a signal path from the control device to the one switch, the first signal level being stored in an output buffer of the control device as a level of the control signal output from an output terminal of the control device, the second signal level indicating a level of a signal input into the first input terminal via the third signal line; and
the determination process includes
a first process of determining, in a case where the first signal level differs from the second signal level, that there is no abnormality, and
a second process of determining, in a case where the first signal level is equal to the second signal level, that there is the abnormality.

3. The power conversion system according to claim 2, wherein the second process is executed solely in a case where a state in which the first signal level is equal to the second signal level continues for at least a time that is predetermined.

4. The power conversion system according to claim 2, further comprising a fourth signal line branching from a portion of the first signal line between the first branch point and the output terminal of the inverter circuit, wherein:
the control device further includes a second input terminal connected to the fourth signal line;
the determination process is executed in accordance with the first signal level, the second signal level, and a third signal level indicating a level of a signal input into the second input terminal via the fourth signal line;
the first process is executed in a case where the first signal level is equal to the third signal level and the first signal level differs from the second signal level; and
the second process is executed in a case where the first signal level differs from the third signal level or in a case where the first signal level is equal to the third signal level and the first signal level is equal to the second signal level.

5. The power conversion system according to claim 2, wherein:
the control device is configured to control external charging in which the power storage device is charged using the power received by the power receiving port; and
the control device is configured to
execute the determination process during the external charging, and
set, in a case where a determination is made in the determination process that there is the abnormality, the first signal level such that the control signal instructs the second switch to open.
